(19) United States
(12) Patent Application Publication
(10) Pub. No.: US 2025/0238889 A1
(43) Pub. Date: Jul. 24, 2025

(54) SYSTEM AND METHOD TO MONITOR TRIP AND DETECT UNSAFE EVENTS

(71) Applicant: GRABTAXI HOLDINGS PTE. LTD., Singapore (SG)

(72) Inventors: Joanne Chieng Hwee CHIEW, Singapore (SG); Haitao BAO, Singapore (SG); Kyle MEASNER, Seattle, WA (US); Miaojun LI, Seattle, WA (US); Tanuj Pradeep JHAWAR, Seattle, WA (US)

(21) Appl. No.: 18/699,704

(22) PCT Filed: Oct. 20, 2022
(86) PCT No.: PCT/SG2022/050747

§ 371 Date: Apr. 9, 2024

(30) Foreign Application Priority Data
Nov. 3, 2021 (SG) 10202112237X

(51) Int. Cl. G06Q 50/26; G01P 13/00; G06Q 50/47

(52) U.S. Cl. CPC G06Q 50/265; G01P 13/00; G06Q 50/47

(57) ABSTRACT

The present invention relates generally to a system and method to monitor trip and detect unsafe events. According to a first aspect, the present disclosure refers to a method for monitoring movement of a vehicle during a ride based on a mobile device associated with the vehicle, comprising: detecting an unusual movement of the vehicle during the monitoring, the unusual movement comprising at least one of a change in speed, route or arrival time of the vehicle; determining an overall risk level based on the unusual movement; triggering a response based on the overall risk level, the response including a request to confirm a status of an occupant of the vehicle; and triggering a followup response based on the status of the occupant.

### TECHNICAL FIELD

The present invention relates generally to a system and method to monitor trip and detect unsafe events.

### BACKGROUND

Ride hailing services involve putting passengers and drivers who do not know each other on trips in close physical proximity. Passengers and drivers are concerned about their safety during the trip, and ride hailing providers wish to ensure their service is safe for their users.

Further, accidents or even criminal activity may happen during such trips, and sometimes result in fatality if help is not rendered in a timely manner. With possibly thousands of such trips occurring at any one time, it is a challenge to ensure safety of every single trip.

A need therefore exists to provide a system and method to monitor trip and detect unsafe events that seek to address the above-mentioned problems.

### SUMMARY

Disclosed are arrangements which seek to address one or more of the above problems by providing a system and method to monitor trip and detect unsafe events. The disclosed arrangements can also be used to monitor a trip based on processing data relating to each element of the trip and trigger an appropriate response upon detection of an unsafe of unusual event.

According to a first aspect, the present disclosure refers to a method for monitoring movement of a vehicle during a ride based on a mobile device associated with the vehicle, comprising: detecting an unusual movement of the vehicle during the monitoring, the unusual movement comprising at least one of a change in speed, route or arrival time of the vehicle; determining an overall risk level based on the unusual movement; triggering a response based on the overall risk level, the response including a request to confirm a status of an occupant of the vehicle; and triggering a followup response based on the status of the occupant; wherein determining the overall risk level further comprises: processing, by one or more risk models, data associated with the ride, the vehicle, and occupants in the vehicle during the ride, wherein the processing of the data by each of the one or more risk models is based on a specific risk, the specific risk comprising at least one of a risk of sexual crime, risk associated with a driver of the vehicle, risk associated with a passenger of the vehicle, risk of occurrence of a crime, risk of a driving accident and risk of an abnormal progress of the ride; assigning a priority to each of the one or more risk levels based on the specific risk associated with each of the one or more risk models, and triggering the response if a risk level of a highest priority exceeds a threshold value, the response being at least one of making a call to an occupant of the vehicle, sending a message to an occupant of the vehicle, activating audio recording of the mobile device, communicating with a next-of-kin of an occupant of the vehicle, requesting assistance from a public service or an incident response team, and continued monitoring of the ride, based on the overall risk level.

According to a second aspect, the present disclosure refers to a system for monitoring movement of a vehicle during a ride based on a mobile device associated with the vehicle, comprising: at least one processor; and at least one memory including computer program code; the at least one memory and the computer program code configured to, with the at least one processor, cause the system at least to: detect an unusual movement of the vehicle during the monitoring, the unusual movement comprising at least one of a change in speed, route or arrival time of the vehicle; determine an overall risk level based on the unusual movement; trigger a response based on the overall risk level, the response including a request to confirm a status of an occupant of the vehicle; and trigger a followup response based on the status of the occupant; wherein determining the overall risk level further comprises: processing, by one or more risk models, data associated with the ride, the vehicle, and occupants in the vehicle during the ride, wherein the processing of the data by each of the one or more risk models is based on a specific risk, the specific risk comprising at least one of a risk of sexual crime, risk associated with a driver of the vehicle, risk associated with a passenger of the vehicle, risk of occurrence of a crime, risk of a driving accident and risk of an abnormal progress of the ride; determining a risk level for each specific risk based on the processed data; assigning a priority to each of the one or more risk levels based on the specific risk associated with each of the one or more risk models, and triggering the response if a risk level of a highest priority exceeds a threshold value, the response being at least one of making a call to an occupant of the vehicle, sending a message to an occupant of the vehicle, activating audio recording of the mobile device, communicating with a next-of-kin of an occupant of the vehicle, requesting assistance from a public service or an incident response team, and continued monitoring of the ride, based on the overall risk level.

### BRIEF DESCRIPTION OF THE DRAWINGS

Some aspects of at least one embodiment of the present invention will now be described with reference to the drawings and appendices, in which:

FIG. 1 illustrates a system for monitoring a trip and detecting unsafe events according to various embodiments;

FIG. 2 illustrates a schematic diagram of a ride monitoring server according to various embodiments;

FIG. 3 shows an overview of a process for monitoring a trip and detecting unsafe events according to various embodiments;

FIG. 4 shows an example illustration of how a status of an occupant in a vehicle may be obtained according to various embodiments;

FIG. 5 is a flow diagram of a monitoring movement of a vehicle during a ride based on a mobile device associated with the vehicle according to various embodiments;

FIGS. 6A and 6B form a schematic block diagram of a general purpose computer system upon which the travel co-ordination server of FIG. 1 can be practiced;

FIGS. 6C is a schematic block diagram of a general purpose computer system upon which the ride monitoring server of FIG. 2 can be practiced;

FIGS. 6D is a schematic block diagram of a general purpose computer system upon which a combined travel co-ordination server and ride monitoring server of FIG. 1 can be practiced;

FIG. 7 shows an example of a computing device to realize the travel co-ordination server shown in FIG. 1;

FIG. 8 shows an example of a computing device to realize the ride monitoring server shown in FIG. 1; and

FIG. 9 shows an example of a computing device to realize a combined travel co-ordination and ride monitoring server shown in FIG. 1.

### DETAILED DESCRIPTION

Embodiments will be described, by way of example only, with reference to the drawings. Like reference numerals and characters in the drawings refer to like elements or equivalents.

Some portions of the description which follows are explicitly or implicitly present-ed in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those re-quiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “monitoring”, “utilizing”, “retrieving”, “providing”, “generating”, “quantifying”, “calculating”, “outputting”, “optimising”, “rebuilding”, “storing”, “mapping”, “checking”, “identifying”, “collecting”, “searching”, “conducting”, “cross-checking”, “aggregating”, “determining”, “regenerating”, “updating”, “comparing”, “adjusting”, “compiling”, “processing”, “triggering”, “performing”, “obtaining” or the like, refer to the action and processes of a computer system, or similar electronic device, that manipulates and transforms data represented as physical quantities within the computer system into other data similarly represented as physical quantities within the computer system or other information storage, transmission or display devices.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the specification.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

A user may be any suitable type of entity, which may include a person, a motorcycle driver or pillion rider, a car driver or passenger, and other similar entity. A user who is registered to the travel co-ordination or ride monitoring server will be called a registered user. A user who is not registered to the travel co-ordination server or ride monitoring server will be called a non-registered user. The term user will be used to collectively refer to both registered and non-registered users. A user may interchangeably be referred to as an occupant e.g. of a vehicle associated with a ride, wherein the occupant may be a driver or a passenger of the vehicle. A user may also be referred to as a requestor (e.g. a person who requests for a ride) or a provider (e.g. a person who provides the requested ride to the requestor).

A ride monitoring server is a server that hosts software application programs for monitoring movement of a vehicle during a ride. The monitoring may be based on a mobile device associated with the vehicle. For example, information may be gathered in real time from the mobile device to detect an unusual movement of the vehicle during the monitoring, wherein the unusual movement may comprise at least one of a change in speed, route or arrival time of the vehicle. An overall risk level based on the unusual movement may be determined, and a response may be triggered based on the overall risk level. The response may include a request to confirm a status of an occupant of the vehicle. Based on the status, a followup response may be triggered.

The travel co-ordination server is a server that hosts software application programs for processing payment transactions or travel co-ordination requests. The travel co-ordination server communicates with any other servers (e.g., a ride monitoring server) concerning travel co-ordination requests. The travel co-ordination server communicates with a ride monitoring server to facilitate monitoring movement of a vehicle during a ride associated with the travel co-ordination request. Travel co-ordination server servers may use a variety of different protocols and procedures in order to process the payment and travel co-ordination requests.

Transactions that may be performed via a travel co-ordination server include product or service purchases, credit purchases, debit transactions, fund transfers, account withdrawals, etc. Travel co-ordination servers may be configured to process transactions via cash-substitutes, which may include payment cards, letters of credit, checks, payment accounts, etc.

The travel co-ordination server is usually managed by a service provider that may be an entity (e.g. a company or organization) which operates to process requests, pair a provider of the travel co-ordination request to a requestor of the travel co-ordination request. The travel co-ordination server may include one or more computing devices that are used for processing travel co-ordination requests.

A travel co-ordination account is an account of a user who is registered at a travel co-ordination server. The user can be a customer, a hail provider (e.g., a driver), or any third parties (e.g., a courier) who want to use the travel co-ordination server. In certain circumstances, the travel co-ordination account is not required to use the ride monitoring server. A travel co-ordination account includes details (e.g., name, address, vehicle etc.) of a user.

The travel co-ordination server manages the travel co-ordination accounts of users and the interactions between users and other external servers.

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which form public knowledge through their use. Such should not be interpreted as a representation by the present inventor(s) or the patent applicant that such devices in any way form part of the common general knowledge in the art.

In the present disclosure, a monitoring system is proposed which has the capability to detect early signs of an on-going incident to help enhance platform safety and provide necessary emergency support. The monitoring system aims to solve the problems of how to detect early signs of an ongoing incident when passenger and driver are en-route (without using video or audio recording) and, upon detection, how to provide timely emergency support. This aims to make taking rides on ride hailing services safer. For the first problem, while there are commercial solutions that allow a ride provider to monitor the ongoings within the car using in-car video camera or audio recording, concerns with these approaches include cost & logistics (e.g. of installing specialized hardware, especially cameras), privacy regulation by governments and concerns from individuals, and collection of data which may not be practical on some vehicles such as motorcycles.

The monitoring system may be a large-scale, real-time system which monitors trip for events (e.g. stops, change in speed, change in a designated route, change in an arrival time, and other similar events). Once an event is detected, the system may use a machine learning model to determine if the event signals an on-going safety incident and/or might develop into a safety incident (e.g. a traffic accident, inter-personnel dispute between occupants in a concerned vehicle, occurrence of a crime, risk of a driving accident, and other similar incidents that may require assistance). The monitoring system may then take action based on an assessed risk level of the detected event.

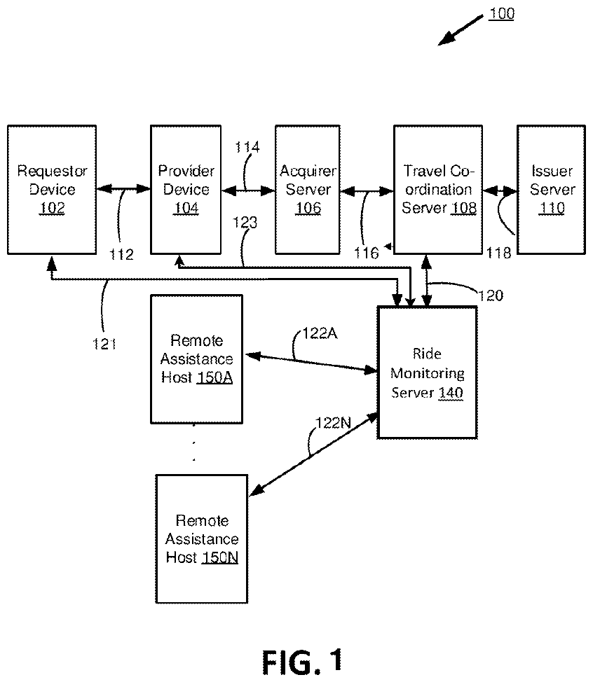

FIG. 1 illustrates a block diagram of a system 100 for monitoring a trip and detecting unsafe events. Further, the system 100 enables a travel request and a payment transaction for a ride between a requestor and a provider.

The system 100 comprises a requestor device 102, a provider device 104, an acquirer server 106, a travel co-ordination server 108, an issuer server 110, a remote assistance server 140 and remote assistance hosts 150A to 150N.

The requestor device 102 is in communication with a provider device 104 via a connection 112. The connection 112 may be wireless (e.g., via NFC communication, Bluetooth, etc.) or over a network (e.g., the Internet). The requestor device 102 is also in communication with the ride monitoring server 140 via a connection 121. The connection 121 may be a network (e.g., the Internet). The requestor device 102 may also be connected to a cloud that facilitates the system 100 for monitoring a trip and detecting unsafe events. For example, the requestor device 102 can send a signal or data to the cloud directly via a wireless connection (e.g., via NFC communication, Bluetooth, etc.) or over a network (e.g., the Internet).

The provider device 104 is in communication with the requestor device 102 as described above, usually via the travel co-ordination server 108. The provider device 104 is, in turn, in communication with an acquirer server 106 via a connection 114. The provider device 104 is also in communication with the ride monitoring server 140 via a connection 123. The connections 114 and 123 may be a network (e.g., the Internet). The provider device 104 may also be connected to a cloud that facilitates the system 100 for monitoring a trip and detecting unsafe events. For example, the provider device 104 can send a signal or data to the cloud directly via a wireless connection (e.g., via NFC communication, Bluetooth, etc.) or over a network (e.g., the Internet).

The acquirer server 106, in turn, is in communication with a travel co-ordination server 108 via a connection 116. The travel co-ordination server 108, in turn, is in communication with an issuer server 110 via a connection 118. The connections 116 and 118 may be a network (e.g., the Internet).

The travel co-ordination server 108 is further in communication with the ride monitoring server 140 via a connection 120. The connection 120 may be over a network (e.g., a local area network, a wide area network, the Internet, etc.). In one arrangement, the travel co-ordination 108 and the ride monitoring server 140 are combined and the connection 120 may be an interconnected bus.

The ride monitoring server 140, in turn, is in communication with the remote assistance hosts 150A to 150N via respective connections 122A to 122N. The connections 122A to 122N may be a network (e.g., the Internet). The ride monitoring server 140 may also be connected to a cloud that facilitates the system 100 for monitoring a trip and detecting unsafe events. For example, the ride monitoring server 140 can send a signal or data to the cloud directly via a wireless connection (e.g., via NFC communication, Bluetooth, etc.) or over a network (e.g., the Internet).

The remote assistance hosts 150A to 150N are servers. The remote assistance hosts 150A to 150N are collectively referred to herein as the remote assistance hosts 150, while the remote assistance host 150 refers to one of the remote assistance hosts 150. The remote assistance hosts 150 may be combined with the ride monitoring server 140. In an example, the remote assistance host 150 may be one managed by a hospital and the ride monitoring server 140 is a central server that manages emergency calls and decides which of the remote assistance hosts 150 to forward an emergency call. Alternatively, a module such as a remote assistance module may perform these functions instead of the ride monitoring server 140, wherein the remote assistance module may be integrated as part of the ride monitoring server 140 or external from the ride monitoring server 140.

In the illustrative embodiment, each of the devices 102, 104, and the servers 106, 108, 110, 140, and 150 provides an interface to enable communication with other connected devices 102, 104, 142 and/or servers 106, 108, 110, 140, and 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for at least one of the requestor device 102 and the provider device 104 to send a response to a status enquiry shown on the GUI running on the respective API, or an alert signal when a user presses a panic button on the GUI running on the respective API. Similarly, it is possible to place a call to an emergency contact as identified by the requestor or the provider when an alert signal or a status response is sent.

Use of the term ‘server’ herein can mean a single computing device or a plurality of interconnected computing devices which operate together to perform a particular function. That is, the server may be contained within a single hardware unit or be distributed among several or many different hardware units.

The ride monitoring server 140 is associated with an entity (e.g. a company or organization or moderator of the service). In one arrangement, the ride monitoring server 140 is owned and operated by the entity operating the travel co-ordination server 108. In such an arrangement, the ride monitoring 140 may be implemented as a part (e.g., a computer program module, a computing device, etc.) of the travel co-ordination server 108.

The ride monitoring server 140 may also be configured to manage the registration of users. A registered user has a ride monitoring account (see the discussion above) which includes details of the user. The registration step is called on-boarding. A user may use either the requestor device 102 or the provider device 104 to perform on-boarding to the ride monitoring server 140.

It is not necessary to have a ride monitoring account at the ride monitoring server 140 to access the functionalities of the ride monitoring server 140. However, there are functions that are available to a registered user. These additional functions will be discussed below.

The on-boarding process for a user is performed by the user through one of the requestor device 102 or the provider device 104. In one arrangement, the user downloads an app (which includes the API to interact with the ride monitoring server 140) to the requestor device 102 or the provider device 104. In another arrangement, the user accesses a website (which includes the API to interact with the ride monitoring server 140) on the requestor device 102 or the provider device 104. The user is then able to interact with the ride monitoring server 140. The user may be a requestor or a provider associated with the requestor device 102 or the provider device 104, respectively.

Details of the registration include, for example, name of the user, address of the user, emergency contact, blood type or other healthcare information, next-of-kin contact, permissions to retrieve data and information from the requestor device 102 and/or the provider device 104 for monitoring movement of a vehicle associated with a ride, and the like. The data for monitoring movement of a vehicle associated with a ride may comprise data retrieved from monitoring at least one of a GPS, accelerometer or gyroscope sensor of the requestor device 102 and/or the provider device 104, wherein the requestor device 102 and/or the provider device 104 may be a mobile device, and the data is based on monitoring at least one of a GPS, accelerometer or gyroscope sensor of the mobile device. Alternatively, another mobile device may be selected instead of the requestor device 102 and/or the provider device 104 for retrieving the data. Once on-boarded, the user would have a ride monitoring account that stores all the details.

The requestor device 102 is associated with a customer (or requestor) who is a party to a travel request that occurs between the requestor device 102 and the provider device 104. The requestor device 102 may be a computing device such as a desktop computer, an interactive voice response (IVR) system, a smartphone, a laptop computer, a personal digital assistant computer (PDA), a mobile computer, a tablet computer, and the like. The requestor device 102 may also be a payment device such as a credit card.

The requestor device 102 includes transaction credentials (e.g., a payment account) of a requestor to enable the requestor device 102 to be a party to a payment transaction. If the requestor has a ride monitoring account, the ride monitoring account may also be included (i.e., stored) in the requestor device 102. For example, a credit card (which is a requestor device 102) may have the ride monitoring account of the customer stored in the credit card. In an alternative arrangement, the ride monitoring account belongs to a user (e.g., a parent or child of the customer) associated with the customer. That is, in the event that an unsafe event is detected and/or a negative status response is obtained from the customer, the parent or child of the customer will be informed accordingly.

In one example arrangement, the requestor device 102 is a computing device in a watch or similar wearable and is fitted with a wireless communications interface (e.g., a NFC interface). The requestor device 102 can then electronically communicate with the provider device 104 regarding a travel request. The customer uses the watch or similar wearable to make request regarding the travel request by pressing a button on the watch or wearable.

The provider device 104 is associated with a provider who is also a party to the travel request that occurs between the requestor device 102 and the provider device 104. The provider device 104 may be a computing device such as a desktop computer, an interactive voice response (IVR) system, a smartphone, a laptop computer, a personal digital assistant computer (PDA), a mobile computer, a tablet computer, and the like. The provider device 104 may also be a payment device such as a credit card.

Hereinafter, the term “provider” refers to a service provider and any third party associated with providing a travel or ride or delivery service via the provider device 104. Therefore, the ride monitoring account of a provider refers to both the ride monitoring account of a provider and the ride monitoring account of a third party (e.g., a travel co-ordinator) associated with the provider.

If the provider has a ride monitoring account, the ride monitoring account may also be included (i.e., stored) in the provider device 104. For example, a credit card (which is a provider device 104) may have the ride monitoring account of the provider stored in the credit card. In an alternative arrangement, the ride monitoring account belongs to a user (e.g., a parent or spouse of the provider) associated with the provider. That is, in the event that an unsafe event is detected and/or a negative status response is obtained from the provider, the parent or child of the provider will be informed accordingly.

In one example arrangement, the provider device 104 is a computing device in a watch or similar wearable and is fitted with a wireless communications interface (e.g., a NFC interface). The provider device 104 can then electronically communicate with the requestor to make request regarding the travel request by pressing a button on the watch or wearable.

The acquirer server 106 is associated with an acquirer who may be an entity (e.g. a company or organization) which issues (e.g. establishes, manages, administers) a payment account (e.g. a financial bank account) of a merchant. Examples of the acquirer include a bank and/or other financial institution. As discussed above, the acquirer server 106 may include one or more computing devices that are used to establish communication with another server (e.g., the travel co-ordination server 108) by exchanging messages with and/or passing information to the other server. The acquirer server 106 forwards the payment transaction relating to a travel request to the travel co-ordination server 108.

The travel co-ordination server 108 is configured to process processes relating to a ride monitoring account by, for example, forwarding data and information associated with a ride, a vehicle associated with the ride, and occupants in the vehicle during the ride, etc to the ride monitoring server 140 for processing to determine an overall risk level of a detected unsafe event relating to the ride.

The issuer server 110 is associated with an issuer and may include one or more computing devices that are used to perform a payment transaction. The issuer may be an entity (e.g. a company or organization) which issues (e.g. establishes, manages, administers) a transaction credential or a payment account (e.g. a financial bank account) associated with the owner of the requestor device 102. As discussed above, the issuer server 110 may include one or more computing devices that are used to establish communication with another server (e.g., the travel co-ordination server 108) by exchanging messages with and/or passing information to the other server.

The remote assistance host 150 is a server associated with an entity (e.g. a company or organization) which manages (e.g. establishes, administers) healthcare resources. In one arrangement, the entity is a hospital. Therefore, each entity operates a remote assistance host 150 to manage the resources by that entity. In one arrangement, a remote assistance host 150 receives an alert signal forwarded by the ride monitoring server 140 indicating, for example, that a user is likely to have met with an accident or fell victim to a crime. The remote assistance host 150 may then arrange to send resources to the location identified by the location information included in the alert signal.

In one arrangement, the alert signal can be automatically updated on the ride monitoring account associated with the user. Advantageously, this allows other healthcare workers to know if a user has had met with other traffic accidents, or police to know if the user has fell victim to a crime.

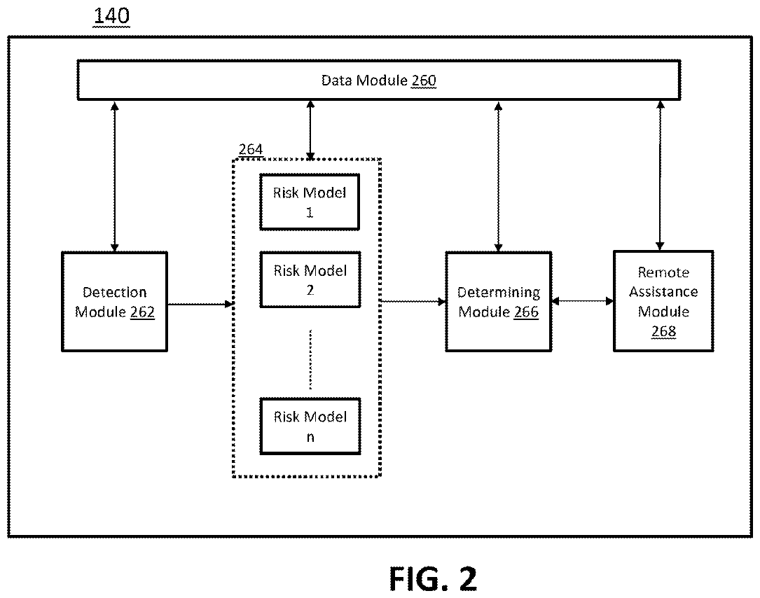

FIG. 2 illustrates a schematic diagram of the ride monitoring server 140 according to various embodiments. The ride monitoring server 140 may comprise a data module 260 configured to receive data and information from the requestor device 102, provider device 104, travel co-ordination server 108, a cloud and other sources of information to facilitate the monitoring of a ride and detecting unsafe events by the ride monitoring server 140. The ride monitoring server 140 may comprise a detection module 262 configured to detect an unusual movement of a vehicle when monitoring the vehicle during a ride, the unusual movement comprising at least one of a change in speed, route or arrival time (e.g. actual arrival time is significantly earlier or later than expected arrival time) of the vehicle. For example, a change in speed may be due to a slowdown, acceleration or stopping of the vehicle, which may be indicative of events such as a driving accident, crash or other possible events. The detection may be based on data obtained from monitoring at least one of a global positioning system (GPS) (speed, latitude, longitude), accelerometer (e.g. acceleration in x, y, z axes) and gyroscope sensor (e.g. bearing) of a mobile device associated with the vehicle. The mobile device may be the requestor device 102, provider device 104, or another selected device for a ride management account associated with the occupant in the concerned vehicle. In an arrangement, the requestor device 102 may be a mobile device of a passenger in the vehicle during the ride, and the provider device 104 may be a mobile device of a driver in the vehicle during the ride. The monitoring of the at least one of the GPS, accelerometer and gyroscope sensor of the concerned mobile device may be performed by the detection module 262 by analysing data generated from these sensors. In an arrangement, the data generated from these sensors may be transmitted from the concerned mobile device to the data module 260, and then from the data module 260 to the detection module 262. In another arrangement, the data generated from these sensors may be transmitted from the concerned mobile device to a cloud, wherein the data module 260 may be configured to retrieve the data from the cloud. Alternatively, the detection module 262 may be configured to receive the data directly from the concerned mobile device or retrieve the data from the cloud storing the data. In another arrangement, the data may be processed on a client side (e.g. on an API on the concerned mobile device) such that a determination of whether an unsafe event is detected is sent from the mobile device to the detection module 262 or directly to risk models 264 (e.g. such that the detection module 262 may not be required).

Other data may also be used to determine whether an unusual movement of the vehicle has occurred, for example general data about the environment (e.g. time), data about the current booking for the concerned ride: (e.g. planned origin location, planned destination location, estimated trip distance, estimated trip time, planned route), data about the behaviour of occupants in the vehicle, e.g. how many cancellations the driver has made before taking the booking, and other similar data. Such information may be retrieved in real time and used to detect if an event of interest such as an unusual movement of the vehicle has occurred (e.g. vehicle has stopped), and features about the event (e.g location where it happened). Such data may be obtained from the internet (e.g. weather report and traffic information), the travel co-ordination server 108 (e.g. information of the ride booking, occupants in the concerned vehicle, payment or credit information, and other similar information), and other similar sources.

The ride monitoring server 140 may comprise one or more risk models 264 configured to, upon detecting (e.g. by the detection module 262) an unusual movement of the vehicle associated with the ride, process data associated with the ride, the vehicle, and occupants in the vehicle during the ride (for example data provided via the data module 260), wherein the processing of the data by each of the one or more risk models is based on a specific risk, and determine a risk level for each specific risk based on the processed data. The specific risk may be at least one of a risk of sexual crime, risk associated with a driver of the vehicle, risk associated with a passenger of the vehicle, risk of occurrence of a crime, risk of a driving accident, risk of an abnormal progress of the ride. risk of a driving related safety incident, risk of less serious interpersonal conflict related incidents (e.g. theft), risk of serious interpersonal conflict related incidents (e.g. assault), risk of other miscellaneous illegal activity (e.g. taking drugs) and other similar risk. The determination of the risk level for each specific risk may further comprise training the one or more models based on a status response received from an occupant in the concerned vehicle (for example via the requestor device 102, provider device 104, or another selected device for a ride monitoring account associated with the occupant in the concerned vehicle) to output a revised risk level for each specific risk of the detected unusual movement. Further, the processing of data by the one or more risk models 264 may be based on one or more feature vectors, each feature vector representing at least one of a contextual information and historical information relating to the ride. Contextual information may comprise a duration of a detected unusual movement, a location at which the unusual movement occurred, start and stop time of the unusual movement, congestion level on road segment when the unusual movement occurred, booking information of the ride, behaviour of occupants of the vehicle, and past events that occurred on the ride, and other similar information. Historical information may comprise historical data about occupants of the vehicle and information about similar past bookings, stops and past unusual movement relating to a location at which the unusual movement occurred, and other similar information. The contextual and historical information may be retrieved from the internet, the requestor device 102, provider device 104, or another selected device for a ride monitoring account associated with the occupant in the concerned vehicle, the travel co-ordination server 108, a cloud storage, and other similar sources, and provided to the risk models 264 via the data module 260.

The ride monitoring server 140 may comprise a determining module 266 that may be configured to determine an overall risk level of a detected unusual movement of the vehicle. For example, the determining module 266 may comprise a decision model configured to process the risk levels determined by the one or more risk models based on business goals, existing resources, possible tradeoffs and other similar considerations, and determine the overall risk level based on the processing. Information and data relating to the business goals, existing resources, possible tradeoffs and other similar considerations may be retrieved from the internet, the requestor device 102, provider device 104, or another selected device for a ride monitoring account associated with the occupant in the concerned vehicle, the travel co-ordination server 108, a cloud storage, and other similar sources, and provided to the determining module 266 via the data module 260.

The ride monitoring server 140 may comprise a remote assistance module 268 that may be configured to trigger a response based on the overall risk level determined by the determining module 266. The response may be sent to the requestor device 102, provider device 104, or another selected device for a ride monitoring account associated with the occupant in the concerned vehicle, and may include a request to confirm a status of an occupant of the vehicle. Based on a provided status from the requestor device 102, provider device 104, or another selected device for a ride monitoring account associated with the occupant in the concerned vehicle in response to the request, the remote assistance module 268 may trigger a followup response. The remote assistance module 268 may further be in communication with the one or more remote assistance hosts 150 to send emergency alerts based on the triggered response or followup response. Triggering the response by the remote assistance module 268 may comprise at least one of making a call to an occupant of the vehicle, sending a message to an occupant of the vehicle, activating audio recording of the mobile device, communicating with a next-of-kin of an occupant of the vehicle, requesting assistance from a public service or an incident response team, continued monitoring of the ride, and other similar response based on the overall risk level. Further, triggering the followup response by the remote assistance module 268 may comprise at least one of making a call to an occupant of the vehicle, communicating with a next-of-kin of an occupant of the vehicle, requesting assistance from a public service or an incident response team, continued monitoring of the ride, and other similar response based on the status of the occupant. In an embodiment, the remote assistance module 268 may be a user-interface, in which a human personnel may make decisions for triggering an appropriate response based on the overall risk level, and/or a ticket system in which a ticket may be generated which may be sent (e.g. over the internet, a dedicated network, and other similar forms of communication) to, for example, an incident response team to take a downstream action. For example, the ticket may comprise details of what action is required based on the overall risk level so that the incident response team can take an appropriate action based on the contents of the ticket. The decision of generating the ticket and the contents in the ticket may be determined by a human personnel managing the ticket system of the remote assistance module 268, or it may be generated automatically based on the overall risk level.

Further, a priority may be assigned to each of the one or more risk levels determined by the one or more risk models 264 based on the specific risk associated with each of the one or more risk models 264. Generally, a specific risk that may be deemed to be of comparatively higher importance (e.g. possibility of a sex crime) would be assigned a higher priority. The determining module 266 may be configured to take into account the assigned priority during the determination of the overall risk level so that specific risks having a higher priority may take precedence. For example, if a specific risk having a high priority is determined to have a risk level that exceeds a certain threshold value, the determining module 266 may determine a high overall risk level to reflect the severity of a possible unsafe event, even if the risk levels of the other specific risks represented by the other one or more risk models 264 may be low. A response may therefore be triggered by the remote assistance module 268 if a risk level of a highest priority exceeds a threshold value. The response may be at least one of making a call to an occupant of the vehicle, sending a message to an occupant of the vehicle, activating audio recording of the mobile device, communicating with a next-of-kin of an occupant of the vehicle, requesting assistance from a public service or an incident response team, and continued monitoring of the ride, based on the overall risk level.

The mechanic of triggering a response based on whether a risk level of highest priority exceeds a threshold value is one implementation of the decision model. It will be appreciated that there can be other ways of doing so. For example, there may be a determination whether a maximum of all risk levels exceeds a threshold value, such that an appropriate response may be configured to be triggered based on this determination. In another example, an action may simply be assigned (e.g. assigning one or more call agents to respond via calling the driver and/or passenger of the monitored vehicle, calling a next-of-kin of the driver and/or passenger, calling an incident response team, or other similar actions) until capacity for that action is reached (e.g. no more call agents available), then no more action will be taken or other alternative actions will then be implemented.

The responses and further responses described above are non-limiting, and it will be appreciated that other possible types of responses may be implemented. The conceptual idea behind the responses and further responses would be real-time intervention based on a predicted severity (e.g. of an unusual event detected during monitoring of a ride) through risk scoring, balancing business and operational constraints. The real-time interventions basically involve: reaching out to (some or all of) the occupants of the vehicle in some form (message, call, automated IVR), and/or reaching out to occupants' next-of-kin, and/or proactively triggering assistance from parties (e.g. public service or an internal incident response team), and/or continued monitoring of the ride (which could include audio recording), as well as other similar responses.

Each of the data module 260, detection module 262, risk models 264, determining module 266 and remote assistance module 268 may further be in communication with a processing module (not shown) of the ride monitoring server 140, for example for coordination of respective tasks and functions during monitoring a ride. The data module 260 may be further configured to communicate with and store data and information for each of the processing module, detection module 262, risk models 264, determining module 266 and remote assistance module 268. Alternatively, all the tasks and functions required for monitoring a ride and detecting an unsafe event may be performed by a single processor of the ride monitoring server 140.

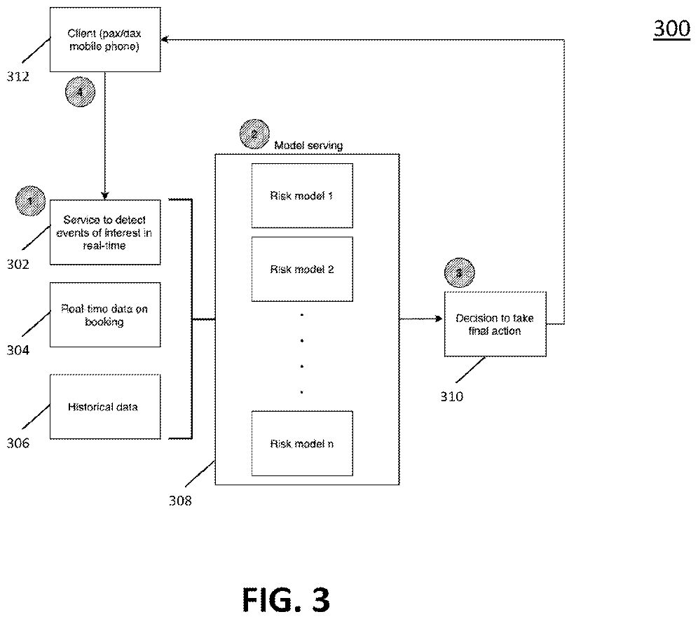

FIG. 3 shows an overview of a process for monitoring a trip and detecting unsafe events according to various embodiments. The process may comprise four parts to its implementation. In a first part, services 302 are utilized to detect events of interest in real-time based on, for example, real-time data 304. For example, real-time data is captured from sensors in a mobile phone of both passengers and driver (e.g. accelerometer, gyroscope and GPS sensors of the requestor device 102, provider device 104, or another selected device for a ride monitoring account associated with the occupant in the concerned vehicle). Data relevant to the trip being monitored may also be retrieved from other sources such as the internet, the travel co-ordination server 108. The obtained data may be sent to a cloud storage, or stored in the data module 260. The data may be processed on a client side (e.g. on the API of the associated mobile device) or server side (e.g. detection module 262) to determine if there are events of interest or an unsafe event (e.g. stops, change in speed, change in a designated route, change in an arrival time (e.g. actual arrival time is significantly earlier or later than expected arrival time) and other similar events). Real-time data 304 may include data from the accelerometer sensor (e.g. acceleration in x, y, z axes), data from the gyroscope sensor (e.g. bearing), data from the GPS sensor (e.g. speed, latitude, longitude), general data about the environment (e.g. time), data about the current booking (e.g. planned origin location, planned destination location, estimated trip distance, estimated trip time, planned route), data about the behaviour of occupants in the vehicle (e.g. how many cancellations the driver has made before taking the booking), and other similar data. These real-time information may be used to detect if an event of interest has occurred (e.g. vehicle has stopped, change in speed, change in a designated route, change in an arrival time (e.g. actual arrival time is significantly earlier or later than expected arrival time) and other similar events), and features about the event (e.g where it happened).

In a second part, after the event is detected, risk modelling 308 may be utilized to determine a risk-level of the detected event. Risk-level is an indication of how risky an event is, e.g. how likely the event is a safety incident. Safety incidents can be of different types, e.g. driving related safety incidents, less serious interpersonal conflict related incidents (e.g. theft), serious interpersonal conflict related incidents (e.g. assault), other miscellaneous illegal activity (e.g. taking drugs). In addition to real-time data 304 as mentioned in the first part above, we also use historical data 306 that may be obtained from the internet, ride booking platform, the travel co-ordination server 108, or other similar sources. Historical behavioural data about occupants in the vehicle (e.g. occupants of the vehicle being monitored, such as the passenger and driver of the vehicle) indicating, for example, how much bad feedback the driver has received from previous passengers in the last 3 months, whether the passenger is new to the platform, whether a passenger has gone through the full identity verification process recently, or other details, historical records of safety incidents that has happened on the concerned ride booking platform (e.g. parties involved in past incidents and investigation details of the incidents), historical data on the location of the event of interest (e.g. whether a location is a known “hotspot” for dangerous events) may be taken into consideration during risk level determination for each specific risk by the one or more risk models 264.

Previous events detected on the same trip being monitored may also be taken into consideration. For example, at the 10 minute mark of a ride, it is detected that the driver was deviating slightly from the suggested route, but the risk models 264 predict that the risk level of this single event is low. At the 15 minute mark of the ride, it is detected that there was a 5-minute stop, but the risk models 264 predict that the risk level of this single event is low. At the 20 minute mark, another 5-minute stop is detected, but the risk models 264 predict that the risk level of this single event is low. Even though the risk level of the stop at the 20 minute mark is low, because of the cumulative set of prior events, risk models 264 may consider this stop at the 20 minute mark for the same trip to be high-risk, and appropriate action such as triggering an appropriate response based on the overall risk level may be taken.

Such data may be used to model the risk level of the event using machine learning (e.g. utilizing the one or more risk models 264). Each of the models 264 would output an estimated risk level for a specific risk of the event (e.g. score between 0 to 1 on how likely an event is part of a safety incident), or they would output a predicted class associated with the event (e.g. whether an event is a specific type of incident, such as an occurrence of a crime, risk of a driving accident, an abnormal progress of the ride, a driving related safety incident, a less serious interpersonal conflict related incident (e.g. theft), a serious interpersonal conflict related incident (e.g. assault), other miscellaneous illegal activity (e.g. taking drugs) and other similar incidents).

For example, a stop may be detected during a monitored trip, and an interpersonal conflict risk level of the detected stop may be predicted. The input to the model predicting the interpersonal conflict risk level is an event of interest and a vector of features associated with the event (e.g. event =stop, with a vector of features=[X₁, X₂, X₃ . . . Xₘ], where there are m features associated with this particular event). The output of the model may be a number from 0 to 1, which indicates the probability that the event is associated with an interpersonal conflict. There may be multiple such models running simultaneously. If there are n models, there will be n outputs being produced, [Y₁, Y₂, Y₃ . . . Yₙ], where 0≤Y≤1 for all I models. Based on all the outputs being produced [Y₁, Y₂, Y₃ . . . Yₙ], there will be another model (e.g. decision model of the determining module 266) that takes in [Y₁, Y₂, Y₃ . . . Yₙ] and outputs a final decision to take, (e.g. to call the passenger, which the remote assistance module 268 executes). On a single trip, multiple models may run at the same time on the same event, and their output may be aggregated. These models may be deployed to run on the mobile device and/or the ride monitoring server 140.

In a third part 310, a decision is made to take a final action in relation to the output of the models e.g. the output of the models may be matched to a decision. A decision is an appropriate action to intervene in the event (e.g. send a message to the passenger's mobile device, call the passenger immediately, and other appropriate actions). In general, the appropriate action taken will be determined by the risk level of the event, business goals and business resources, with the appropriate tradeoffs made between these considerations. For example. a safety team call center may only have capacity to handle X calls a day, so the most risky/high impact X events are prioritized for calling as a response. For less risky events, we may just send the passenger a message asking if the passenger is ok.

For a single booking, if multiple models predict high risk for different kinds of risk, an additional layer of logic may be applied to determine the appropriate action to take. For example, to avoid user friction as a result of repeatedly contacting (and therefore annoying) an occupant of the concerned vehicle, it may be set as a rule that a passenger may only be contacted once on a booking regardless of how many unsafe events are detected. It will be appreciated that various other rules relating to such customer service considerations and other similar considerations may be applied to the monitoring system to advantageously enhance user experience while monitoring a trip for unsafe events.

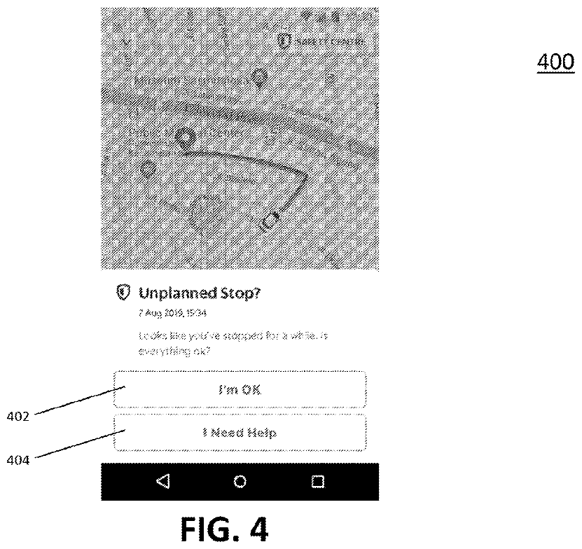

In a fourth part 312, after an action or response is taken, the ride monitoring system may collect responses from the passengers/driver to verify their status (e.g. message to ask if they are ok and collect their response, call and see if that is answered) and use this information to further decide on the action to take. For example, a message such as shown in interface illustration 400 of FIG. 4 may be sent to a passenger upon detection of a stop during a monitored trip to ask for a status of the passenger to see if the passenger is ok. The message may be sent for example as a notification in the ride monitoring and/or trip booking API that is installed in a mobile device of the passenger (e.g. the requestor device 102 or another selected device for a ride monitoring account associated with the passenger). If the passenger replies to the message saying he is ok e.g. by clicking on button 402, no further action may be taken. If the passenger replies to the message asking for help e.g. by clicking on button 404, a further response may be triggered, for example by making a call to the passenger, requesting assistance from a public service or an incident response team, continued monitoring of the ride, or a combination of these actions.

The collected passenger/driver response may be used to refine the event risk modelling and real-time event detection (e.g. if a passenger responds that the event did not occur even though the one or more models 260 and decision model of the determining module 266 predicted so, the models will be updated and retrained using this feedback). In addition to actions taken through the ride monitoring and/or trip booking mobile application (e.g. messaging, direct to help center), there may also be other actions that are taken outside of the mobile application (such as, for example, an incident response team (IRT) staff calling the passenger or driver associated with the monitored trip).

A specific use case of a high-risk event detected via an unplanned stop in a monitored trip based on the four parts of the trip monitoring system as described above may be as follows:

### 1) Real Time Stop Detection

On the ride monitoring server 140, the detection module 262 is configured to detect an unusual movement of the vehicle during the monitoring, the unusual movement comprising at least one of a change in speed, route or arrival time (e.g. actual arrival time is significantly earlier or later than expected arrival time) of the vehicle.

A general description of the stop detection algorithm is as follows. Once the booking starts or the driver has picked up the passenger, GPS signals are proactively checked from the driver's and/or passengers' mobile devices at fixed intervals (e.g. every minute), to track the speed and location of the devices. The detection module 262 may be run on fixed time intervals of this data (e.g. every minute) to determine the vehicle's status. For example, in a minute, if the vehicle does not move faster than a certain speed threshold, the detection module 262 may determine that it has stopped. A distance check may be performed by calculating the distance the vehicle has travelled from a fixed time point before the detected stop, taking into account GPS accuracy. If the vehicle has not travelled further than a certain distance threshold, the vehicle may be considered to be not moving as well. For each interval of data being considered, a result of a status check on a present interval (e.g. time-based and/or distance-based interval) may be considered together with the result of the status check for previous intervals, to conclude the vehicle's status for the past X intervals. For example, if a vehicle is currently stopped for this minute, and has been in stopped status for the past 9 minutes, the detection module 262 may determine that the vehicle has stopped for the past 10 minutes.

For the present example, a 10 minute stop may have been detected (across last 10 minutes' status checks). Other characteristics of this stop may also be computed and taken into account, such as location of the stop, what time the stop started, congestion level along the road segment where the stop occurred, etc.

### 2) Modelling the Risk Level of the Stop

A risk level associated with this detected stop may then be computed. Some of the features that may be used for the computation may include contextual information such as relating to the detected stop (e.g. duration (e.g. 10 minutes), location (latitude and longitude), start and stop time of stop, congestion level on road segment when stop occurred), the booking of the monitored trip (e.g. time of pickup, origin and destination location, estimated time of arrival at destination, distance of the booked trip, payment mode (cash/digital wallet)), behaviour of occupants of car (e.g. number of cancellations in the 1 hour before driver picked up the passenger), past events that occurred during the ride (e.g. number of stops and unusual events (e.g. passenger accesses safety center or uses a feature that allows sharing of the ride with another person) that happened prior to this stop), and other similar information. The computation may also include historical information such as historical data about the occupants of vehicle (e.g. how long have the passenger and driver been active on the platform, average rating of the passenger and driver received from past trips, whether the passenger and driver have been associated with any past incidents on the ride booking platform, and other similar information), historical information about similar bookings or stops (e.g. whether the location at which the stop occurred tends to be isolated/high crime area, whether long stops are common in this area, etc), and other similar information.

These features of the ride monitoring system may be made available in real-time for the risk modelling to be done once the stop is detected. For those features that have to be computed in real-time, there will be services that do the computation of the concerned feature. For those that are based on historical data and/or information, these features may be pre-computed regularly (e.g. daily) and made available to the ride monitoring system when needed. Such computations may be performed by, for example, the processor of the ride monitoring server 140, or a computation server that is external to the ride monitoring server 140. The relevant features are then collected and represented in a vector [X₁, X₂, X₃ . . . Xₘ] for m features, which will be sent to the one or more risk models 264 for prediction. Transformations such as encoding/binning may be performed on the features.

Multiple machine learning risk models 264 may be simultaneously run on a detected stop. Some models that may be run for predicting risk levels associated with the detected stop may include a model for risk of sexual crime (e.g. some factors that will increase risk level are whether the passenger and driver are opposite gender, whether the driver has history of receiving complaints from passengers about sexual/harassment issues), a model for general risk level of driver (e.g. some factors that may increase risk level are whether the driver is very new to the platform such that not much information is known about the driver, whether the driver account might be compromised, whether the driver cancelled many times before the booking), a model for general risk level of passenger (e.g. some factors that may increase risk level are whether the passenger is very new to the platform, or has been dormant for a long time and came back recently, or has not gone through any authentication checks recently, for example taken a selfie), a model for good opportunity to commit crime (e.g. some factors that may increase risk are if the stop happens at night, the area is isolated and/or dark, and other similar factors), a model for abnormal ride progress (e.g. some factors that may increase risk are if a route taken to that point at which the vehicle is detected to have stopped seems to deviate from an expected route that should have been taken by the vehicle for the monitored trip, slow progress of ride given time that has elapsed, many unusual events detected before this stop, and other similar factors), and other similar models.

Each of the above-described models may return a score between 0 and 1, which indicates a risk level for the model's specific type of risk. In this example, there may be 5 models running, which will lead to 5 outputs being produced, for example represented by [Y₁, Y₂, Y₃, Y₃, Y₄, Y₅], where 0Yi≤1 for all i. This may happen in real-time after the stop is detected.

### 3) Decide What Action to Take and Take the Action in Real-Time

For example, risk levels [0.9, 0.1, 0.3, 0.5, 0.8] may be obtained from the 5 models that are ran as described above. Another model (e.g. the decision model of the determining module 266) may be trained to take in the predictions from individual models to output an action to take. Examples of actions are: make a call to the passenger and/or driver, do nothing, send a message to pax/dax, turn on audio recording, and other similar actions.

The decision on what action to take may be decided by the determining module 266 based on business goals and business resources as well as the predicted risk level of the event. Higher risk level events may be prioritized for more costly (and effective) interventions. As a simplistic illustration, for example, it is believed that sexual crimes are of a very high priority to the ride booking platform because of high human impact. Therefore, as long as a risk model 1 (for example, for predicting the specific risk of sexual crime) gives a prediction of >0.75, regardless of other model predictions, the triggered response will be to assign an IRT agent to call the passenger and driver immediately.

If the calculated risk levels for the models were lower but still suggestive (e.g. relatively high score for risk level of drunken conflict), the decision model may be trained to decide to send a passage to the passenger and/or driver to request them to confirm if they are ok. This is a less effective intervention but because of the lower business cost, it is possible to reach out to more people with this response. If the scores for all the risk models 264 are very low, e.g. 0.1, the decision model may predict that nothing should be done.

The decision on what to do as a response will be made by trading off predicted risk level & business goals and resources. Previous events and previously calculated risk levels may be saved e.g. via the data module 260, so that they are available to be considered for a next event that comes in. There may be other business logic applied for the decision on what action to take, for example setting a rule that a driver that has been called more than 3 times in a day should not be called any further, so as to reduce user friction,.

The remote assistance module 268 may be configured to automatically execute the decided action depending on the output of the decision model. Some possible actions based on score (in increasing order of proactiveness) may include:
Send passenger and/or driver in-app alerts (e.g. push notifications/bottom sheets)
Send passenger and/or driver voice broadcast alert using the respective mobile device of the passenger and/or driver
Automated interactive voice response (IVR) outbound call with options to escalate to internal incident response teams, call police or ambulance

Manually communicate with passenger, driver, and/or their next-of-kin, and/or manually dispatch help based on scenario (e.g. deploying a nearest driver, police, ambulance)

### 4) Verification and Offline Support

The remote assistance module 268 may be configured to automatically execute the decided action depending on the output of the decision model. Based on this action, it is possible to obtain information on the status of the passenger/driver/vehicle to verify their status. Followup actions or responses after the initial action can be determined based on a received status from the passenger/driver/vehicle, and/or determined in advance and carried out accordingly (like a standard operating procedure). For example, the decision model predicts that we should send a push notification to the passenger and/or driver to request them to confirm that they are ok. The standard operating procedure could state that if they reply that “they need help” or do not reply within a certain time frame, the next followup response would be escalated to calling them.

In addition to actions taken through the mobile application (e.g. messaging, direct to help center), there may also be other actions that may be taken offline, such as an IRT staff calling the passenger and/or driver, an IRT staff tracking the progress of the vehicle in real-time, and other similar actions.

The status responses provided by the passenger and/or driver may be further used to refine the risk models 264 and the decision model of the determining module 266 so that the models can learn from feedback. For example, if the passenger and/or driver responds to the enquiry of a triggered response from the remote assistance module 268 that they are actually ok despite the models predicting a high risk of an incident, the models may be retrained to return a lower risk score for this event next time by learning the issue (e.g. there is a tunnel in this area that always causes an impression of a long stop when there is none).

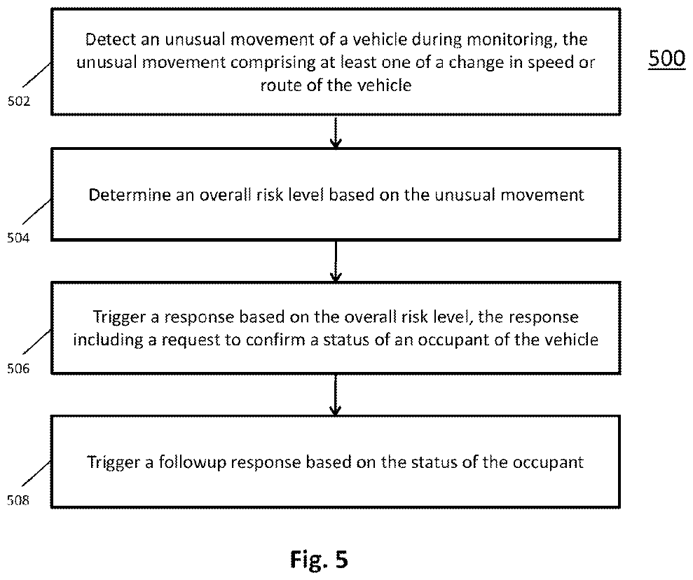

FIG. 5 depicts a flow chart of a method for monitoring movement of a vehicle during a ride based on a mobile device associated with the vehicle according to various embodiments. In step 502, an unusual movement of a vehicle is detected during monitoring, the unusual movement comprising at least one of a change in speed, route or arrival time of the vehicle. In step 504, an overall risk level is determined based on the unusual movement. In step 506, a response is triggered based on the overall risk level, the response including a request to confirm a status of an occupant of the vehicle. In step 508, a followup response is triggered based on the status of the occupant.

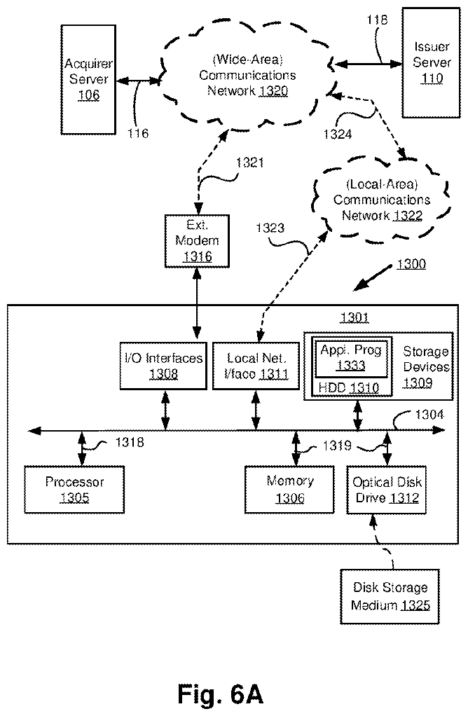

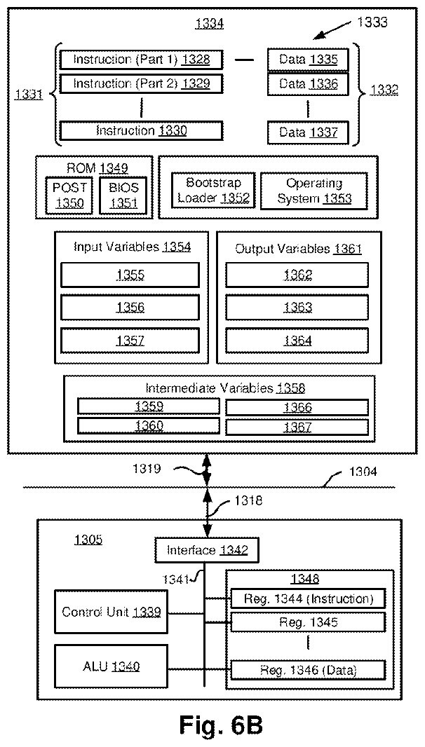

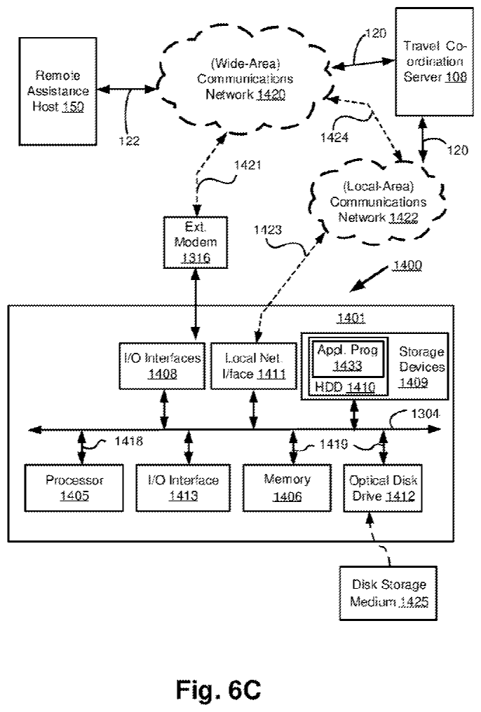

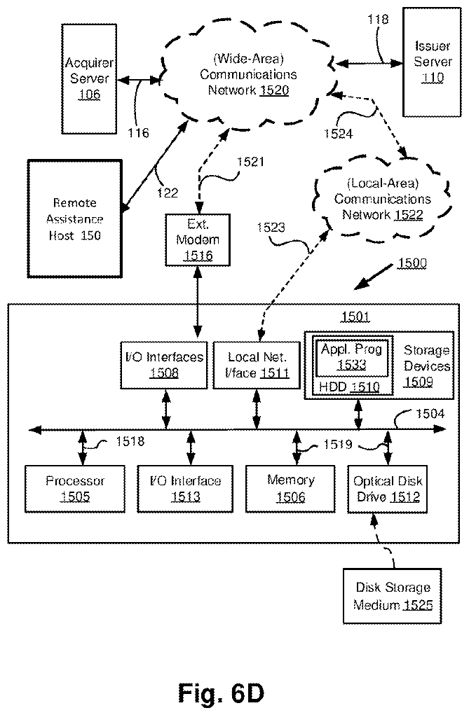

FIGS. 6A and 6B depict a general-purpose computer system 1300, upon which the travel co-ordination server 108 described can be practiced.

As seen in FIG. 6A, the computer system 1300 includes a computer module 1301. An external Modulator-Demodulator (Modem) transceiver device 1316 may be used by the computer module 1301 for communicating to and from a communications network 1320 via a connection 1321. The communications network 1320 may be a wide-area network (WAN), such as the Internet, a cellular telecommunications network, or a private WAN. Where the connection 1321 is a telephone line, the modem 1316 may be a traditional “dial-up” modem. Alternatively, where the connection 1321 is a high capacity (e.g., cable) connection, the modem 1316 may be a broadband modem. A wireless modem may also be used for wireless connection to the communications network 1320.

The computer module 1301 typically includes at least one processor unit 1305, and a memory unit 1306. For example, the memory unit 1306 may have semiconductor random access memory (RAM) and semiconductor read only memory (ROM). The computer module 1301 also includes an interface 1308 for the external modem 1316. In some implementations, the modem 1316 may be incorporated within the computer module 1301, for example within the interface 1308. The computer module 1301 also has a local network interface 1311, which permits coupling of the computer system 1300 via a connection 1323 to a local-area communications network 1322, known as a Local Area Network (LAN). As illustrated in FIG. 6A, the local communications network 1322 may also couple to the wide network 1320 via a connection 1324, which would typically include a so-called “firewall” device or device of similar functionality. The local network interface 1311 may comprise an Ethernet circuit card, a Bluetooth® wireless arrangement or an IEEE 802.11 wireless arrangement; however, numerous other types of interfaces may be practiced for the interface 1311.

The I/O interfaces 1308 may afford either or both of serial and parallel connectivity, the former typically being implemented according to the Universal Serial Bus (USB) standards and having corresponding USB connectors (not illustrated). Storage devices 1309 are provided and typically include a hard disk drive (HDD) 1310. Other storage devices such as a floppy disk drive and a magnetic tape drive (not illustrated) may also be used. An optical disk drive 1312 is typically provided to act as a non-volatile source of data. Portable memory devices, such optical disks, USB-RAM, portable, external hard drives, and floppy disks, for example, may be used as appropriate sources of data to the system 1300.

The components 1305 to 1312 of the computer module 1301 typically communicate via an interconnected bus 1304 and in a manner that results in a conventional mode of operation of the computer system 1300 known to those in the relevant art. For example, the processor 1305 is coupled to the system bus 1304 using a connection 1318. Likewise, the memory 1306 and optical disk drive 1312 are coupled to the system bus 1304 by connections 1319. Examples of computers on which the described arrangements can be practised include IBM-PC's and compatibles, Sun Sparcstations, Apple or like computer systems.

The steps of the method 500 in FIG. 5 facilitated by the travel co-ordination server 108 may be implemented using the computer system 1300. The steps of the method 500 may be implemented as one or more software application programs 1333 executable within the computer system 1300. In particular, the steps of the method 500 as facilitated by the travel co-ordination server 108 are effected by instructions 1331 (see FIG. 6B) in the software 1333 that are carried out within the computer system 1300. The software instructions 1331 may be formed as one or more code modules, each for performing one or more particular tasks. The software may also be divided into two separate parts, in which a first part and the corresponding code modules facilitates the steps of the method 500 and a second part and the corresponding code modules manage a user interface between the first part and the user.

The software may be stored in a computer readable medium, including the storage devices described below, for example. The software is loaded into the computer system 1300 from the computer readable medium, and then executed by the computer system 1300. A computer readable medium having such software or computer program recorded on the computer readable medium is a computer program product. The use of the computer program product in the computer system 1300 preferably effects an advantageous apparatus for a travel co-ordination server 108.

The software 1333 is typically stored in the HDD 1310 or the memory 1306. The software is loaded into the computer system 1300 from a computer readable medium. and executed by the computer system 1300. Thus, for example, the software 1333 may be stored on an optically readable disk storage medium (e.g., CD-ROM) 1325 that is read by the optical disk drive 1312. A computer readable medium having such software or computer program recorded on it is a computer program product. The use of the computer program product in the computer system 1300 preferably effects an apparatus for a travel co-ordination server 108.

In some instances, the application programs 1333 may be supplied to the user encoded on one or more CD-ROMs 1325 and read via the corresponding drive 1312, or alternatively may be read by the user from the networks 1320 or 1322. Still further, the software can also be loaded into the computer system 1300 from other computer readable media. Computer readable storage media refers to any non-transitory tangible storage medium that provides recorded instructions and/or data to the computer system 1300 for execution and/or processing. Examples of such storage media include floppy disks, magnetic tape, optical disk, a hard disk drive, a ROM or integrated circuit, USB memory, a magneto-optical disk, or a computer readable card such as a PCMCIA card and the like, whether or not such devices are internal or external of the computer module 1301. Examples of transitory or non-tangible computer readable transmission media that may also participate in the provision of software, application programs, instructions and/or data to the computer module 1301 include radio or infra-red transmission channels as well as a network connection to another computer or networked device, and the Internet or Intranets including e-mail transmissions and information recorded on Websites and the like.

The second part of the application programs 1333 and the corresponding code modules mentioned above may be executed to implement one or more graphical user interfaces (GUIs) to be rendered or otherwise represented upon a display. Through manipulation of typically a keyboard and a mouse, a user of the computer system 1300 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

FIG. 6B is a detailed schematic block diagram of the processor 1305 and a “memory” 1334. The memory 1334 represents a logical aggregation of all the memory modules (including the HDD 1309 and semiconductor memory 1306) that can be accessed by the computer module 1301 in FIG. 6A.

When the computer module 1301 is initially powered up, a power-on self-test (POST) program 1350 executes. The POST program 1350 is typically stored in a ROM 1349 of the semiconductor memory 1306 of FIG. 6A. A hardware device such as the ROM 1349 storing software is sometimes referred to as firmware. The POST program 1350 examines hardware within the computer module 1301 to ensure proper functioning and typically checks the processor 1305, the memory 1334 (1309, 1306), and a basic input-output systems software (BIOS) module 1351, also typically stored in the ROM 1349, for correct operation. Once the POST program 1350 has run successfully, the BIOS 1351 activates the hard disk drive 1310 of FIG. 6A. Activation of the hard disk drive 1310 causes a bootstrap loader program 1352 that is resident on the hard disk drive 1310 to execute via the processor 1305. This loads an operating system 1353 into the RAM memory 1306, upon which the operating system 1353 commences operation. The operating system 1353 is a system level application, executable by the processor 1305, to fulfil various high level functions, including processor management, memory management, device management, storage management, software application interface, and generic user interface.

The operating system 1353 manages the memory 1334 (1309, 1306) to ensure that each process or application running on the computer module 1301 has sufficient memory in which to execute without colliding with memory allocated to another process. Furthermore, the different types of memory available in the system 1300 of FIG. 6A must be used properly so that each process can run effectively. Accordingly, the aggregated memory 1334 is not intended to illustrate how particular segments of memory are allocated (unless otherwise stated), but rather to provide a general view of the memory accessible by the computer system 1300 and how such is used.

As shown in FIG. 6B, the processor 1305 includes a number of functional modules including a control unit 1339, an arithmetic logic unit (ALU) 1340, and a local or internal memory 1348, sometimes called a cache memory. The cache memory 1348 typically includes a number of storage registers 1344-1346 in a register section. One or more internal busses 1341 functionally interconnect these functional modules. The processor 1305 typically also has one or more interfaces 1342 for communicating with external devices via the system bus 1304, using a connection 1318. The memory 1334 is coupled to the bus 1304 using a connection 1319.

The application program 1333 includes a sequence of instructions 1331 that may include conditional branch and loop instructions. The program 1333 may also include data 1332 which is used in execution of the program 1333. The instructions 1331 and the data 1332 are stored in memory locations 1328, 1329, 1330 and 1335, 1336, 1337, respectively. Depending upon the relative size of the instructions 1331 and the memory locations 1328-1330, a particular instruction may be stored in a single memory location as depicted by the instruction shown in the memory location 1330. Alternately, an instruction may be segmented into a number of parts each of which is stored in a separate memory location, as depicted by the instruction segments shown in the memory locations 1328 and 1329.

In general, the processor 1305 is given a set of instructions which are executed therein. The processor 1305 waits for a subsequent input, to which the processor 1305 reacts to by executing another set of instructions. Each input may be provided from one or more of a number of sources, including data generated by one or more of the input devices 1302, 1303, data received from an external source across one of the networks 1320, 1302, data retrieved from one of the storage devices 1306, 1309 or data retrieved from a storage medium 1325 inserted into the corresponding reader 1312, all depicted in FIG. 6A. The execution of a set of the instructions may in some cases result in output of data. Execution may also involve storing data or variables to the memory 1334.

The disclosed travel co-ordination server 108 arrangements use input variables 1354, which are stored in the memory 1334 in corresponding memory locations 1355, 1356, 1357. The travel co-ordination server 108 arrangements produce output variables 1361, which are stored in the memory 1334 in corresponding memory locations 1362, 1363, 1364. Intermediate variables 1358 may be stored in memory locations 1359, 1360, 1366 and 1367.

Referring to the processor 1305 of FIG. 6B, the registers 1344, 1345, 1346, the arithmetic logic unit (ALU) 1340, and the control unit 1339 work together to perform sequences of micro-operations needed to perform “fetch, decode, and execute” cycles for every instruction in the instruction set making up the program 1333. Each fetch, decode, and execute cycle comprises:

a fetch operation, which fetches or reads an instruction 1331 from a memory location 1328, 1329, 1330;

a decode operation in which the control unit 1339 determines which instruction has been fetched; and
an execute operation in which the control unit 1339 and/or the ALU 1340 execute the instruction.

Thereafter, a further fetch, decode, and execute cycle for the next instruction may be executed. Similarly, a store cycle may be performed by which the control unit 1339 stores or writes a value to a memory location 1332.

Each step or sub-process in the processes of FIGS. 2A and 2B, as performed by the travel co-ordination server 108, is associated with one or more segments of the program 1333 and is performed by the register section 1344, 1345, 1347, the ALU 1340, and the control unit 1339 in the processor 1305 working together to perform the fetch, decode, and execute cycles for every instruction in the instruction set for the noted segments of the program 1333.

It is to be understood that the structural context of the computer system 1300 (i.e., the travel co-ordination server 108) is presented merely by way of example. Therefore, in some arrangements, one or more features of the server 1300 may be omitted. Also, in some arrangements, one or more features of the server 1300 may be combined together. Additionally, in some arrangements, one or more features of the server 1300 may be split into one or more component parts.

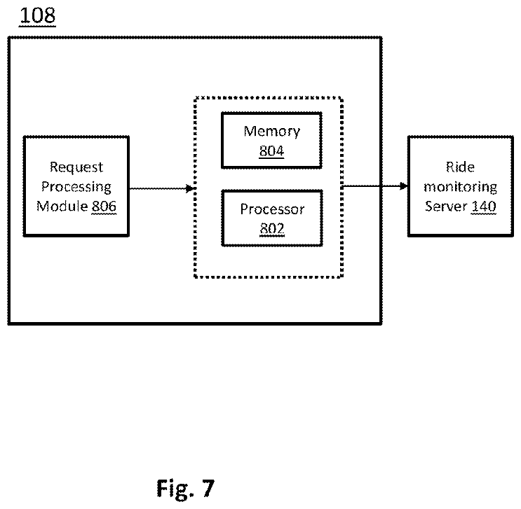

FIG. 7 shows an alternative implementation of the travel co-ordination server 108 (i.e., the computer system 1300). In the alternative implementation, the travel co-ordination server 108 may be generally described as a physical device comprising at least one processor 802 and at least one memory 804 including computer program codes. The at least one memory 804 and the computer program codes are configured to, with the at least one processor 802, cause the travel co-ordination server 108 to facilitate the operations described in the method 500. The travel co-ordination server 108 may also include a transaction request processing module 806. The memory 804 stores computer program code that the processor 802 compiles to have each of the modules 806 and 808 performs their respective functions.

With reference to FIG. 1, the travel request processing module 806 performs the function of communicating with the requestor device 102 and the provider device 104; and the acquirer server 106 and the issuer server 110 to respectively receive and transmit a travel request message. Further, the travel co-ordination server 108 provides data and information associated with a ride, a vehicle associated with the ride, and occupants in the vehicle during the ride, etc to the ride monitoring server 140 for processing to determine an overall risk level of a detected unsafe event relating to the ride.

FIG. 6C depict a general-purpose computer system 1400, upon which the ride monitoring server 140 described can be practiced. The computer system 1400 includes a computer module 1401. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1416 may be a broadband modem. A wireless modem may also be used for wireless connection to the communications network 1420.

The computer module 1401 typically includes at least one processor unit 1405, and a memory unit 1406. For example, the memory unit 1406 may have semiconductor random access memory (RAM) and semiconductor read only memory (ROM). The computer module 1401 also includes an interface 1408 for the external modem 1416. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 6C, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of interfaces may be practiced for the interface 1411.

The I/O interfaces 1408 may afford either or both of serial and parallel connectivity, the former typically being implemented according to the Universal Serial Bus (USB) standards and having corresponding USB connectors (not illustrated). Storage devices 1409 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks, USB-RAM, portable, external hard drives, and floppy disks, for example, may be used as appropriate sources of data to the system 1400.

The components 1405 to 1412 of the computer module 1401 typically communicate via an interconnected bus 1404 and in a manner that results in a conventional mode of operation of the computer system 1400 known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun Sparcstations, Apple or like computer systems.

The method 500, where performed by the ride monitoring server 140 may be implemented using the computer system 1400. The processes may be implemented as one or more software application programs 1433 executable within the computer system 1400. In particular, the sub-processes 400, 500, and 600 are effected by instructions (see corresponding component 1331 in FIG. 6B) in the software 1433 that are carried out within the computer system 1400. The software instructions may be formed as one or more code modules, each for performing one or more particular tasks. The software may also be divided into two separate parts, in which a first part and the corresponding code modules performs the methods and a second part and the corresponding code modules manage a user interface between the first part and the user.

The software may be stored in a computer readable medium, including the storage devices described below, for example. The software is loaded into the computer system 1400 from the computer readable medium, and then executed by the computer system 1400. A computer readable medium having such software or computer program recorded on the computer readable medium is a computer program product. The use of the computer program product in the computer system 1400 preferably effects an advantageous apparatus for a ride monitoring server 140.

The software 1433 is typically stored in the HDD 1410 or the memory 1406. The software is loaded into the computer system 1400 from a computer readable medium, and executed by the computer system 1400. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the computer system 1400 preferably effects an apparatus for a ride monitoring server 140.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the computer system 1400 from other computer readable media. Computer readable storage media refers to any non-transitory tangible storage medium that provides recorded instructions and/or data to the computer system 1400 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more graphical user interfaces (GUIs) to be rendered or otherwise represented upon a display. Through manipulation of typically a keyboard and a mouse, a user of the computer system 1400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1400 (i.e., the ride monitoring server 140) is presented merely by way of example. Therefore, in some arrangements, one or more features of the server 1400 may be omitted. Also, in some arrangements, one or more features of the server 1400 may be combined together.

Additionally, in some arrangements, one or more features of the server 1400 may be split into one or more component parts.

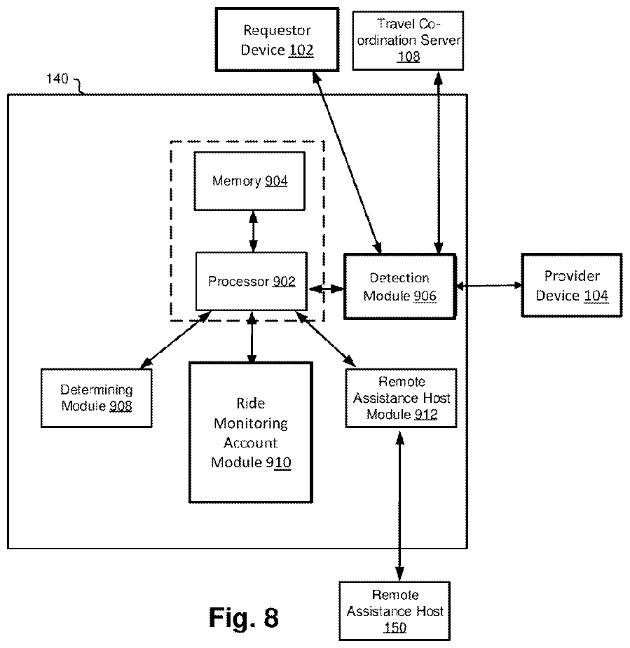

FIG. 8 shows an alternative implementation of the ride monitoring server 140 (i.e., the computer system 1400). In the alternative implementation, ride monitoring server 140 may be generally described as a physical device comprising at least one processor 902 and at least one memory 904 including computer program codes. The at least one memory 904 and the computer program codes are configured to, with the at least one processor 902, cause the ride monitoring server 140 to perform the operations described in the methods 200, 300 and 400. The ride monitoring server 140 may also include a detection module 906, a determining module 908, a ride monitoring account module 910, and a remote assistance host module 912. The memory 904 stores computer program code that the processor 902 compiles to have each of the modules 906 to 912 performs their respective functions.

With reference to FIGS. 1 to 5, the detection module 906 performs the function of detecting an unusual movement of a vehicle during a monitoring of a ride, the unusual movement comprising at least one of a change in speed, route or arrival time of the vehicle.

With reference to FIGS. 1 to 5, the determining module 908 performs the function of determining an overall risk level based on the unusual movement.

With reference to FIG. 1, the ride monitoring account module 910 performs the function of managing (e.g., establishing, updating, etc.) the ride monitoring accounts of users.

With reference to FIGS. 1 to 5, the remote assistance host module 912 performs the function of communicating with the remote assistance host 150, triggering a response based on the overall risk level, the response including a request to confirm a status of an occupant of the vehicle, and triggering a followup response based on the status of the occupant.

FIG. 6D depicts a general-purpose computer system 1500, upon which a combined travel co-ordination server 108 and ride monitoring server 140 described can be practiced. The computer system 1500 includes a computer module 1501. An external Modulator-Demodulator (Modem) transceiver device 1516 may be used by the computer module 1501 for communicating to and from a communications network 1520 via a connection 1521. The communications network 1520 may be a wide-area network (WAN), such as the Internet, a cellular telecommunications network, or a private WAN. Where the connection 1521 is a telephone line, the modem 1516 may be a traditional “dial-up” modem. Alternatively, where the connection 1521 is a high capacity (e.g., cable) connection, the modem 1516 may be a broadband modem. A wireless modem may also be used for wireless connection to the communications network 1520.

The computer module 1501 typically includes at least one processor unit 1505, and a memory unit 1506. For example, the memory unit 1506 may have semiconductor random access memory (RAM) and semiconductor read only memory (ROM). The computer module 1501 also includes an interface 1508 for the external modem 1516. In some implementations, the modem 1516 may be incorporated within the computer module 1501, for example within the interface 1508. The computer module 1501 also has a local network interface 1511, which permits coupling of the computer system 1500 via a connection 1523 to a local-area communications network 1522, known as a Local Area Network (LAN). As illustrated in FIG. 6D, the local communications network 1522 may also couple to the wide network 1520 via a connection 1524, which would typically include a so-called “firewall” device or device of similar functionality. The local network interface 1511 may comprise an Ethernet circuit card, a Bluetooth® wireless arrangement or an IEEE 802.11 wireless arrangement; however, numerous other types of interfaces may be practiced for the interface 1511.

The I/O interfaces 1508 may afford either or both of serial and parallel connectivity, the former typically being implemented according to the Universal Serial Bus (USB) standards and having corresponding USB connectors (not illustrated). Storage devices 1509 are provided and typically include a hard disk drive (HDD) 1510. Other storage devices such as a floppy disk drive and a magnetic tape drive (not illustrated) may also be used. An optical disk drive 1512 is typically provided to act as a non-volatile source of data. Portable memory devices, such optical disks, USB-RAM, portable, external hard drives, and floppy disks, for example, may be used as appropriate sources of data to the system 1500.

The components 1505 to 1512 of the computer module 1501 typically communicate via an interconnected bus 1504 and in a manner that results in a conventional mode of operation of the computer system 1500 known to those in the relevant art. For example, the processor 1505 is coupled to the system bus 1504 using a connection 1518. Likewise, the memory 1506 and optical disk drive 1512 are coupled to the system bus 1504 by connections 1519. Examples of computers on which the described arrangements can be practised include IBM-PC's and compatibles, Sun Sparcstations, Apple or like computer systems.

The steps of the method 500 performed by the ride monitoring server 140 and facilitated by the travel co-ordination server 108 may be implemented using the computer system 1500. The steps of the method 500 as performed by the ride monitoring server 140 may be implemented as one or more software application programs 1533 executable within the computer system 1500. In particular, the steps of the methods 500 are effected by instructions (see corresponding component 1331 in FIG. 6B) in the software 1533 that are carried out within the computer system 1500. The software instructions may be formed as one or more code modules, each for performing one or more particular tasks. The software may also be divided into two separate parts, in which a first part and the corresponding code modules performs the steps of the method 500 and a second part and the corresponding code modules manage a user interface between the first part and the user.

The software may be stored in a computer readable medium, including the storage devices described below, for example. The software is loaded into the computer system 1500 from the computer readable medium, and then executed by the computer system 1500. A computer readable medium having such software or computer program recorded on the computer readable medium is a computer program product. The use of the computer program product in the computer system 1500 preferably effects an advantageous apparatus for a combined travel co-ordination server 108 and ride monitoring server 140.

The software 1533 is typically stored in the HDD 1510 or the memory 1506. The software is loaded into the computer system 1500 from a computer readable medium, and executed by the computer system 1500. Thus, for example, the software 1533 may be stored on an optically readable disk storage medium (e.g., CD-ROM) 1525 that is read by the optical disk drive 1512. A computer readable medium having such software or computer program recorded on it is a computer program product. The use of the computer program product in the computer system 1500 preferably effects an apparatus for a combined travel co-ordination server 108 and ride monitoring server 140.

In some instances, the application programs 1533 may be supplied to the user encoded on one or more CD-ROMs 1525 and read via the corresponding drive 1512, or alternatively may be read by the user from the networks 1520 or 1522. Still further, the software can also be loaded into the computer system 1500 from other computer readable media. Computer readable storage media refers to any non-transitory tangible storage medium that provides recorded instructions and/or data to the computer system 1500 for execution and/or processing. Examples of such storage media include floppy disks, magnetic tape, optical disc, a hard disk drive, a ROM or integrated circuit, USB memory, a magneto-optical disk, or a computer readable card such as a PCMCIA card and the like, whether or not such devices are internal or external of the computer module 1501. Examples of transitory or non-tangible computer readable transmission media that may also participate in the provision of software, application programs, instructions and/or data to the computer module 1501 include radio or infra-red transmission channels as well as a network connection to another computer or networked device, and the Internet or Intranets including e-mail transmissions and information recorded on Websites and the like.

The second part of the application programs 1533 and the corresponding code modules mentioned above may be executed to implement one or more graphical user interfaces (GUIs) to be rendered or otherwise represented upon a display. Through manipulation of typically a keyboard and a mouse, a user of the computer system 1500 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

It is to be understood that the structural context of the computer system 1500 (i.e., combined travel co-ordination server 108 and ride monitoring server 140) is presented merely by way of example. Therefore, in some arrangements, one or more features of the server 1500 may be omitted. Also, in some arrangements, one or more features of the server 1500 may be combined together. Additionally, in some arrangements, one or more features of the server 1500 may be split into one or more component parts.

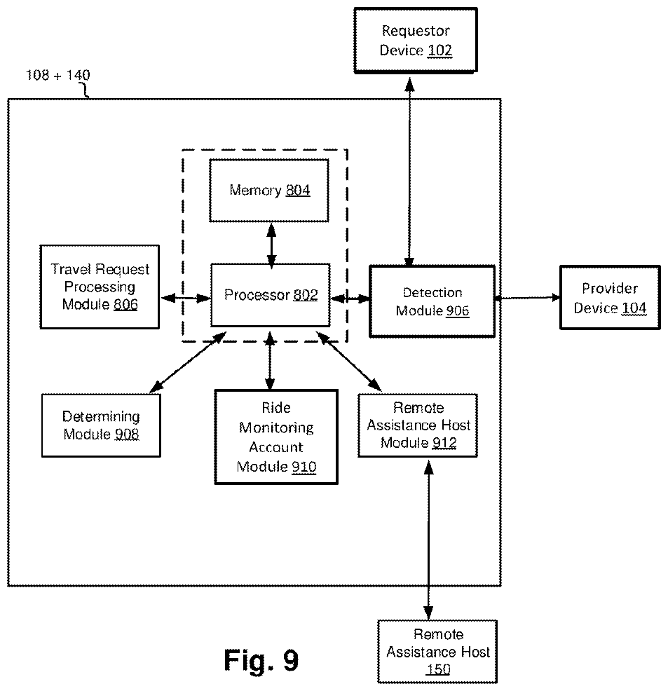

FIG. 9 shows an alternative implementation of the combined travel co-ordination server 108 and ride monitoring server 140 (i.e., the computer system 1500). In the alternative implementation, the combined travel co-ordination server 108 and ride monitoring server 140 may be generally described as a physical device comprising at least one processor 1002 and at least one memory 904 including computer program codes. The at least one memory 1004 and the computer program codes are configured to, with the at least one processor 1002, cause the combined travel co-ordination server 108 and ride monitoring server 140 to perform the operations described in the steps of the method 500. The combined travel co-ordination server 108 and ride monitoring server 140 may also include a transaction request processing module 806, a detection module 906, a determining module 908, a ride monitoring account module 910, and a remote assistance host module 912. The memory 1004 stores computer program code that the processor 1002 compiles to have each of the modules 806 to 912 performs their respective functions.

With reference to FIG. 1, the request (or travel request) processing module 806 performs the function of communicating with the requestor device 102 and the provider device 104; and the acquirer server 106 and the issuer server 110 to respectively receive and transmit a travel request message.

With reference to FIGS. 1 to 5, the detection module 906 performs the function of detecting an unusual movement of a vehicle during a monitoring of a ride, the unusual movement comprising at least one of a change in speed, route or arrival time of the vehicle.

With reference to FIGS. 1 to 5, the determining module 908 performs the function of determining an overall risk level based on the unusual movement.

With reference to FIG. 1, the ride monitoring account module 910 performs the function of managing (e.g., establishing, updating, etc.) the ride monitoring accounts of users.

With reference to FIGS. 1 to 5, the remote assistance host module 912 performs the function of communicating with the remote assistance host 150, triggering a response based on the overall risk level, the response including a request to confirm a status of an occupant of the vehicle, and triggering a followup response based on the status of the occupant.

### INDUSTRIAL APPLICABILITY

The arrangements described are applicable to the computer and data processing industries and particularly for the fields of road traffic management and healthcare resource allocation.

The foregoing describes only some embodiments of the present invention, and modifications and/or changes can be made thereto without departing from the scope and spirit of the invention, the embodiments being illustrative and not restrictive.

1. A method for monitoring movement of a vehicle during a ride based on a mobile device associated with the vehicle, comprising:
detecting an unusual movement of the vehicle during the monitoring, the unusual movement comprising at least one of a change in speed, route or arrival time of the vehicle;
determining an overall risk level based on the unusual movement;
triggering a response based on the overall risk level, the response including a request to confirm a status of an occupant of the vehicle; and
triggering a followup response based on the status of the occupant;
wherein determining the overall risk level further comprises:
processing, by one or more risk models, data associated with the ride, the vehicle, and occupants in the vehicle during the ride, wherein the processing of the data by each of the one or more risk models is based on a specific risk, the specific risk comprising at least one of a risk of sexual crime, risk associated with a driver of the vehicle, risk associated with a passenger of the vehicle, risk of occurrence of a crime, risk of a driving accident and risk of an abnormal progress of the ride;
determining a risk level for each specific risk based on the processed data;
assigning a priority to each of the one or more risk levels based on the specific risk associated with each of the one or more risk models, and triggering the response if a risk level of a highest priority exceeds a threshold value, the response being at least one of making a call to an occupant of the vehicle, sending a message to an occupant of the vehicle, activating audio recording of the mobile device, communicating with a next-of-kin of an occupant of the vehicle, requesting assistance from a public service or an incident response team, and continued monitoring of the ride, based on the overall risk level.

2. The method according to claim 1, wherein monitoring the movement of the vehicle further comprises monitoring at least one of a GPS, accelerometer or gyroscope sensor of the mobile device.

3. The method according to claim 1, wherein determining the risk level for each specific risk further comprises training the one or more models based on the status to output a revised risk level for each specific risk of the detected unusual movement.

4. The method according to claim 1, wherein the processing is further based on one or more feature vectors, each feature vector representing at least one of a contextual information and historical information relating to the ride, wherein
contextual information comprises a duration of the unusual movement, a location at which the unusual movement occurred, start and stop time of the unusual movement, congestion level on road segment when the unusual movement occurred, booking information of the ride, behaviour of occupants of the vehicle, and past events that occurred on the ride; and
historical information comprises historical data about occupants of the vehicle and information about similar past bookings, stops and past unusual movement relating to a location at which the unusual movement occurred.

5. The method according to claim 1, wherein determining the overall risk level further comprises:
processing, by a decision model, the risk levels determined by the one or more risk models, business goals, existing resources and possible tradeoffs; and
determining the overall risk level based on the processing.

6. The method according to claim 1, wherein triggering the response comprises at least one of making a call to an occupant of the vehicle, sending a message to an occupant of the vehicle, activating audio recording of the mobile device, communicating with a next-of-kin of an occupant of the vehicle, requesting assistance from a public service or an incident response team, and continued monitoring of the ride, based on the overall risk level.

7. The method according to claim 1, wherein triggering the followup response comprises at least one of making a call to an occupant of the vehicle, communicating with a next-of-kin of an occupant of the vehicle, requesting assistance from a public service or an incident response team, and continued monitoring of the ride, based on the status of the occupant.

8. A system for monitoring movement of a vehicle during a ride based on a mobile device associated with the vehicle, comprising:
at least one processor; and
at least one memory including computer program code;
the at least one memory and the computer program code configured to, with the at least one processor, cause the system at least to:
detect an unusual movement of the vehicle during the monitoring, the unusual movement comprising at least one of a change in speed, route or arrival time of the vehicle;
determine an overall risk level based on the unusual movement;
trigger a response based on the overall risk level, the response including a request to confirm a status of an occupant of the vehicle; and
trigger a followup response based on the status of the occupant;
wherein determining the overall risk level further comprises:
processing, by one or more risk models, data associated with the ride, the vehicle, and occupants in the vehicle during the ride, wherein the processing of the data by each of the one or more risk models is based on a specific risk, the specific risk comprising at least one of a risk of sexual crime, risk associated with a driver of the vehicle, risk associated with a passenger of the vehicle, risk of occurrence of a crime, risk of a driving accident and risk of an abnormal progress of the ride;
determining a risk level for each specific risk based on the processed data;
assigning a priority to each of the one or more risk levels based on the specific risk associated with each of the one or more risk models, and triggering the response if a risk level of a highest priority exceeds a threshold value, the response being at least one of making a call to an occupant of the vehicle, sending a message to an occupant of the vehicle, activating audio recording of the mobile device, communicating with a next-of-kin of an occupant of the vehicle, requesting assistance from a public service or an incident response team, and continued monitoring of the ride, based on the overall risk level.

9. The system according to claim 8, further configured to:
monitor at least one of a GPS, accelerometer or gyroscope sensor of the mobile device.

10. The system according to claim 8, further configured to:
train the one or more models based on the status to output a revised risk level for each specific risk of the detected unusual movement.

11. The system according to claim 8, further configured to:
Process the data based on one or more feature vectors, each feature vector representing at least one of a contextual information and historical information relating to the ride, wherein
contextual information comprises a duration of the unusual movement, a location at which the unusual movement occurred, start and stop time of the unusual movement, congestion level on road segment when the unusual movement occurred, booking information of the ride, behaviour of occupants of the vehicle, and past events that occurred on the ride; and
historical information comprises historical data about occupants of the vehicle and information about similar past bookings, stops and past unusual movement relating to a location at which the unusual movement occurred.

12. The system according to claim 8, further configured to:
process, by a decision model, the risk levels determined by the one or more risk models based on business goals, existing resources and possible tradeoffs; and
determine the overall risk level based on the processing.

13. The system according to claim 8, further configured to:
trigger the response comprising at least one of making a call to an occupant of the vehicle, sending a message to an occupant of the vehicle, activating audio recording of the mobile device, communicating with a next-of-kin of an occupant of the vehicle, requesting assistance from a public service or an incident response team, and continued monitoring of the ride, based on the overall risk level.

14. The system according to claim 8, further configured to:
trigger the followup response comprising at least one of making a call to an occupant of the vehicle, communicating with a next-of-kin of an occupant of the vehicle, requesting assistance from a public service or an incident response team, and continued monitoring of the ride, based on the status of the occupant.
